(19) United States
(12) Patent Application Publication
(10) Pub. No.: US 2007/0287375 A1
(43) Pub. Date: Dec. 13, 2007

(54) Air cabinet

(75) Inventor: Pan Yung Shuen, Taipei County (TW)

Correspondence Address: REED SMITH LLP, Suite 1400, 3110 Fairview Park Drive, Falls Church, VA, 22042, US

(73) Assignee: Gudeng Precision Industrial Co., Ltd.

(21) Appl. No.: 11/509,698

(22) Filed: Aug. 25, 2006

(30) Foreign Application Priority Data
Jun. 9, 2006 (KR) 95210061

(51) Int. Cl. B01L 1/04

(52) U.S. Cl. 454/187

(57) ABSTRACT

An air cabinet for photomask box is disclosed. A plurality of laminates each formed with punching holes are provided in the air cabinet. These laminates are arranged in parallel with the punching holes of the upper one facing the punching holes of the lower one, so that the caused laminar flow improves the cleanliness of the photomask box and ensures the mask inside the box against pollution when air flow through these punching ho

### BACKGROUND OF THE INVENTION

1. Field of the Invention

The prevent invention relates to an air cabinet, and more particularly to an air cabinet for storing photomask boxes.

2. Description of the Related Art

In semiconductor fabrication, photomask boxes are used for carrying photomasks to isolate the photomasks from the contact of air and prevent from the fogging effect occurring on the surface of photomasks. Especially under current requirement of SMIF, there is a need to effectively improve the isolation of photomasks inside the photomask box from the air in order to extend the duration of photomasks and further decrease the factory manufacturing cost and improve the product yield.

It is well known that a photomask box is usually put in an ordinary cabinet or anywhere in the IC manufacturing process; however, this may cause the nitrogen inside the photomask box to become diluted and the effect of isolating air cannot be achieved so that the photomask inside the photomask box contacts air, fogging effect occurs on its surface, and the photomask is unusable and regarded as scrap.

### BRIEF SUMMARY OF THE INVENTION

The air cabinet of the prevent invention is applied in semiconductor industry to provide a storing space of low humidity, wherein a laminar flow and circulation of air in the air cabinet are used to maintain the environment for long-term storage of photomask pieces.

A plurality of laminates formed with punching holes are disposed inside the body of air cabinet of the present invention. The laminates are parallel to each other and a plurality of punching holes are disposed on each of the laminates. The punching holes on the upper laminate and the punching holes on the bottom laminate are vertically opposite to each other to allow the air to pass through. Specifically, the air passing through the vertically opposite punching holes on the laminates results in laminar flow circulating inside and filling the air cabinet. Thus, the isolation of photomask box from the atmosphere can be improved and the objects inside the photomask box can be protected from being polluted.

In one embodiment of the present invention, the air cabinet further comprises an ULPA filtering unit which includes a fan and an ULPA filtering screen for filtering larger molecules in the air to further improve the cleanliness inside the air cabinet. In another embodiment, the air cabinet of the present invention comprises not only an ULPA filtering unit but also a chemical filter for removing the chemical substances mixed in the air to improve the isolation of photomask box from the atmosphere and prevent objects inside the photomask box from being polluted.

### BRIEF DESCRIPTION OF THE DRAWINGS

FIG. 1 is a schematic diagram showing an air cabinet for photomask box according to the first embodiment of the invention.

FIG. 2 is a schematic diagram showing the composition of the control unit of the air cabinet for photomask box according to the first embodiment of the invention.

FIG. 3 is a schematic diagram showing the laminates with punching holes placed inside the air cabinet for photomask box according to the first embodiment of the invention.

FIG. 4 is a schematic diagram showing an air cabinet for photomask box according to the second embodiment of the invention.

FIG. 5 is a schematic diagram showing the composition of the control unit of the air cabinet for photomask box according to the second embodiment of the invention.

FIG. 6 is a schematic diagram showing the laminates with punching holes placed inside the air cabinet for photomask box according to the second embodiment of the invention.

FIG. 7 is a schematic diagram showing an air cabinet for photomask box according to the third embodiment of the invention.

FIG. 8 is a schematic diagram showing the laminates with punching holes placed inside the air cabinet for photomask box according to the third embodiment of the invention.

FIG. 9 is a schematic diagram showing the bottom laminate and the punching holes thereof of the air cabinet for photomask box according to the third embodiment of the invention.

FIG. 10 is a schematic diagram showing an ULPA filtering screen of the air cabinet for photomask box according to the second and the third embodiments of the invention.

### DETAILED DESCRIPTION OF THE INVENTION

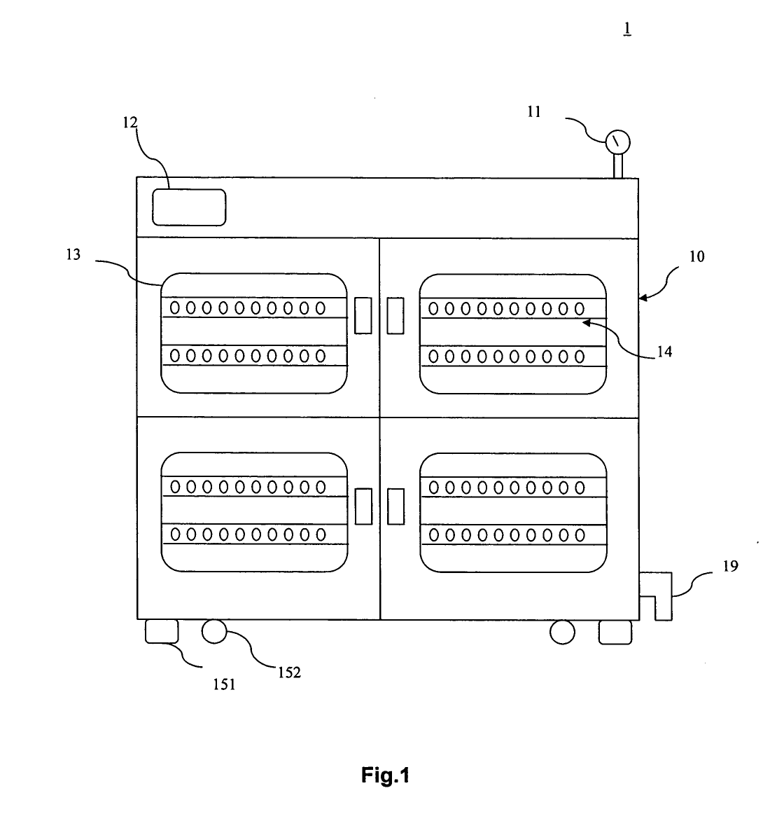

Referring to FIGS. 1, 4 and 7, the air cabinet for storing photomask boxes according to various embodiments of the present invention used in semiconductor industry is disclosed.

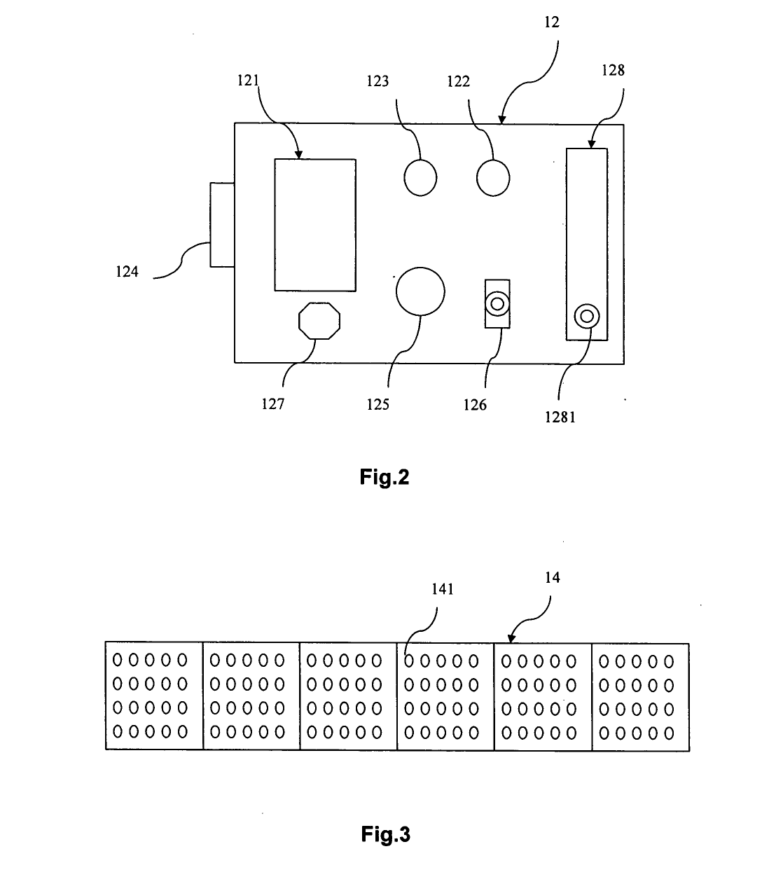

Referring to FIGS. 1, 2 and 3, the air cabinet 1 for storing photomask boxes according to first embodiment of the present invention includes an air cabinet body 10, a pressure gage 11, a control unit 12, a plurality of laminates 14 each formed with punching holes and an air exhausting valve 19, wherein the control unit 12 is mounted on the air cabinet body 10 and the laminates 14 are placed inside the air cabinet body 10. The control unit 12 includes therein a timer 121, indicating lamps 122 and 123, a first buzzer 124, a second buzzer 125, an air cabinet power switch 126, an air extracting button 127 and a flowmeter 128 such as an electronic flowmeter.

The control unit 12 is used to control the flow and the entrance of the air in the air cabinet body. In the present embodiment, when the air cabinet power switch 126 in the control unit 12 is switched ON, the indicating lamp 122, a green lamp for example, lights to show that an inflow is in action. The flowmeter knob 1281 is adjustable that the float inside the flowmeter 128 can reach a required position. The air exhausting valve 19 below the air cabinet body 10 is in charge of exhausting the surplus air when the pressure gage 11 shows that the pressure inside the air cabinet body 10 is overloaded. The first buzzer 124 rings and the counting of the timer 121 starts when the air extracting button 127 is pressed. Afterward, the indicating lamp 122 lights and the air starts to flow into the cabinet after the 15-second assurance that the door of the cabinet is closed. In addition, every time when the door of the cabinet is going to be opened, the user must press the air extracting button 127 first to prevent a lot of air from pouring out to avoid possible damages to human bodies. If the door is not completely closed after it is opened, the second buzzer 125 rings and the indicating lamp 123, a red lamp for example, lights until the door is closed.

A plurality of laminates 14 each formed with punching holes 141 are placed inside the air cabinet body 10. Especially, the laminates 14 are transversely placed inside the air cabinet body 10 and parallel to each other, whereas the punching holes 141 are vertically opposite to each other to allow the air to pass through. Specifically, the air passes through the punching holes 141 and can result in laminar flow circulating inside the air cabinet 10 when air enters the air cabinet body 10. In one embodiment of the present invention, there can be at least six layers of laminates 14, each layer with one laminate, or thirty-six punching-hole-plates inside the air cabinet 10 for each laminate 14 being composed of six pieces of punching-hole-plate.

On the other hand, the air cabinet body 10 includes a plurality of glass windows 13 for observing the placement of the photomask box (not shown) inside the air cabinet body 10. In addition, there are adjustable foot anchors 151 and actuating wheel 152 under the air cabinet body 10, in which the adjustable foot anchors 151 have anti-slip and electrically conductive iron chain for eliminating static electricity of the air cabinet body 10, and the actuating wheel 152 facilitates the movement of the air cabinet.

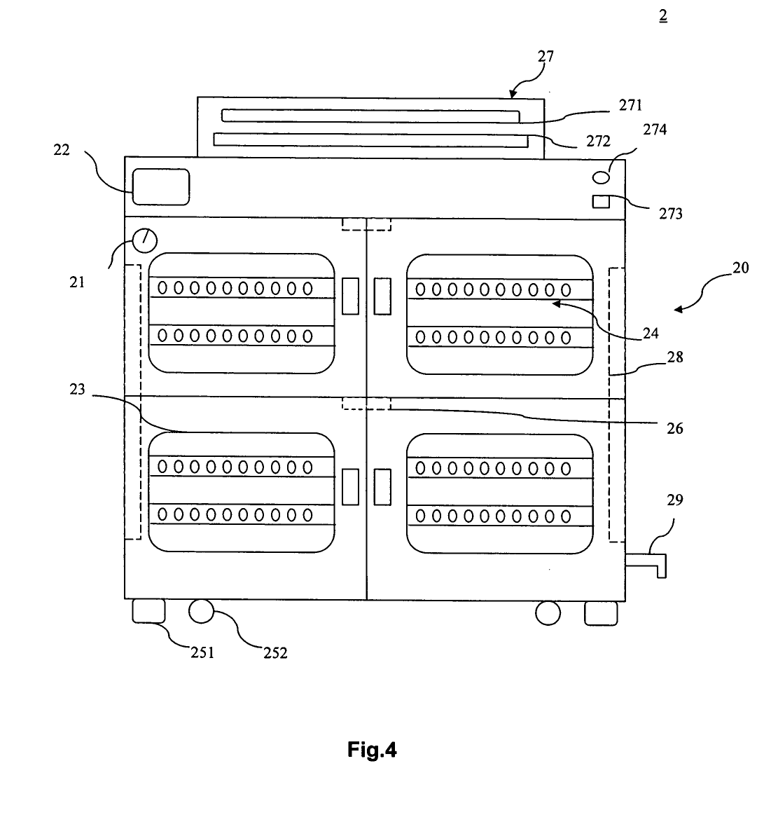

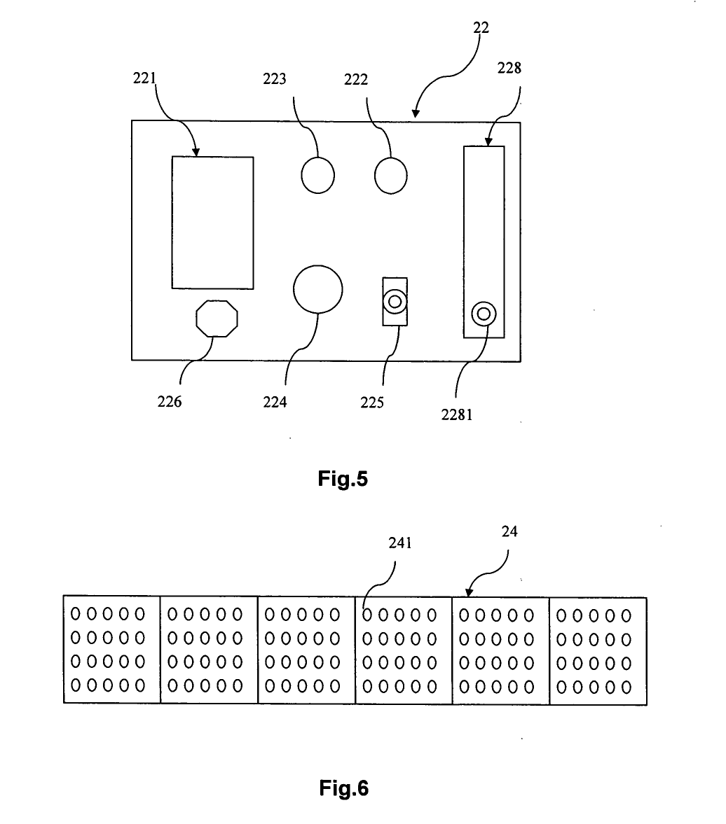

Referring then to FIGS. 4, 5 and 6, the air cabinet 2 for photomask boxes according to the second embodiment of the present invention includes an air cabinet body 20, a temperature-hydrometer 21, a control unit 22, an ultra low penetration air (ULPA) filtering unit 27, two air return tubes 28, an air exhausting valve 29 and a plurality of laminates 24 each formed with punching holes.

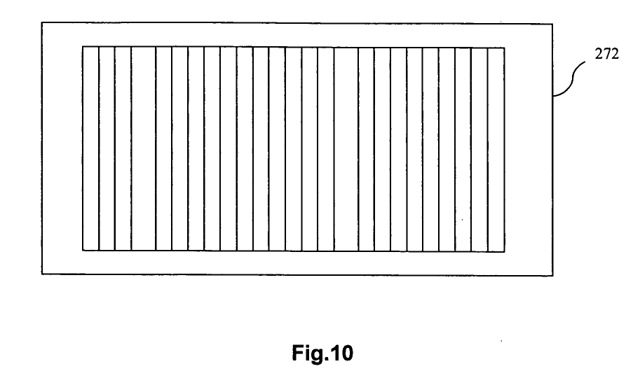

The control unit 22 according to the present embodiment is used to control the flow and the entrance of the air and includes a timer 221, an indicating lamp 222, an indicating lamp 223, a buzzer 224, an air cabinet power switch 225, a air extracting button 226 and a flowmeter 228 such as an electronic flowmeter, a pressure gauge, or a hydrometer. The ULPA filtering unit 27 including a fan 271 and an ULPA filtering screen 272 such as shown in FIG. 10 is mounted above the air cabinet body 20. The ULPA filtering unit 27 is used to filter and dry the air before the air enters the cabinet body 20 so that the molecule of the air entering air cabinet is less than 0.5 μm in diameter. When a photomask box is stored in this air cabinet, since the laminar flow effect caused by the air fills the air cabinet body with air at any time, the effect of isolating the photomask from the atmosphere can be enhanced. Thus, not only can the photomask box be stored in a dry, airy environment, objects inside the mask can also be protected from pollution. In addition, the present invention does not limit the kind of air filled in the air cabinet. Thus the air can be an inert gas, nitrogen, carbon dioxide, etc. Even air mixed with the above air at certain percentages can also be applied in the present invention.

The indicating lamp 222, a green lamp for example, lights when a user turns on the air cabinet power switch 225 to show that an inflow is in action. At the same time, the power switch 273 for the ULPA filtering unit 27 and the tachometer 274 for controlling the speed of the fan 271 can be activated to adjust the air flow into the air cabinet body 20. The fan 271 draws in the air, which goes through the ULPA filtering screen 272, and then the dried and uniforms air is emitted. The temperature-hydrometer 21 on the air cabinet is used to monitor the temperature and the humidity inside the air cabinet body and can thus ensure certain low humidity state. When the entering air flow is too much, the user can adjust the flowmeter knob 2281, a throttle valve for example, to let the float of the flowmeter 228 reach the required position, and the surplus air can be exhausted from the air exhausting valve 29 below the cabinet body 20.

A plurality of laminates 24 each formed with punching holes 241 are placed inside the air cabinet body 20. Especially, each of the laminates 24 is composed of six pieces of punching-hole-plate and is transversely placed inside the air cabinet body 20 and parallel to each other. The punching holes 241 are vertically opposite to each other to allow the air to pass through. In the present embodiment, there can be at least six layers of laminates and two laminates for each layer or seventy-two punching-hole-plates inside the air cabinet 10 for each laminate 24 being composed of six pieces of punching-hole-plate.

On the other hand, two air return tubes 28 are respectively mounted on two sides (such as left and right sides, or front and back sides, or two adjacent sides) of the air cabinet body 20. The air passes through the ULPA filtering screen 272, enters the air cabinet body 20, passes downward through the punching holes 241 and then passes the air return tubes 28 to form a cycle inside the air cabinet 1. Furthermore, there are a plurality of reed switches 26 mounted on the inner side of each door of the air cabinet body 20. The timer 221 starts to count when the cabinet door is opened and the buzzer 224 rings and the indicating lamp 223, a red lamp for example, lights to show that the cabinet door is in an open state if the cabinet door is opened for a time exceeding a set period, 15 seconds for example. In this way, the open state of the cabinet door of the air cabinet 20 can be monitored to prevent the air from escaping out of the cabinet and affecting the condition of storage. There are also a plurality of electrically conductive glass windows 23 disposed on the air cabinet body 20 for observing the placement of the photomask box inside the cabinet and eliminating the static electricity of the air cabinet body 20. In addition, there are adjustable foot anchors 251 and actuating wheel 252 disposed under the air cabinet body 20, wherein the adjustable foot anchors 251 have anti-slip and electrically conductive iron chain for eliminating static electricity of the air cabinet body 20 and the actuating wheel 252 facilitates the movement of the air cabinet 2.

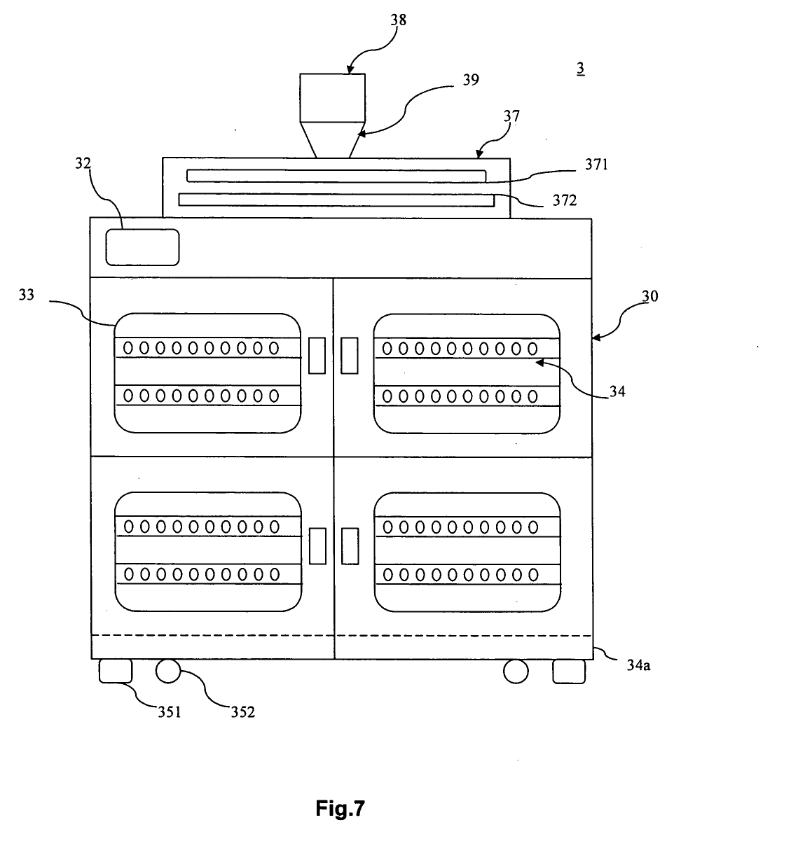

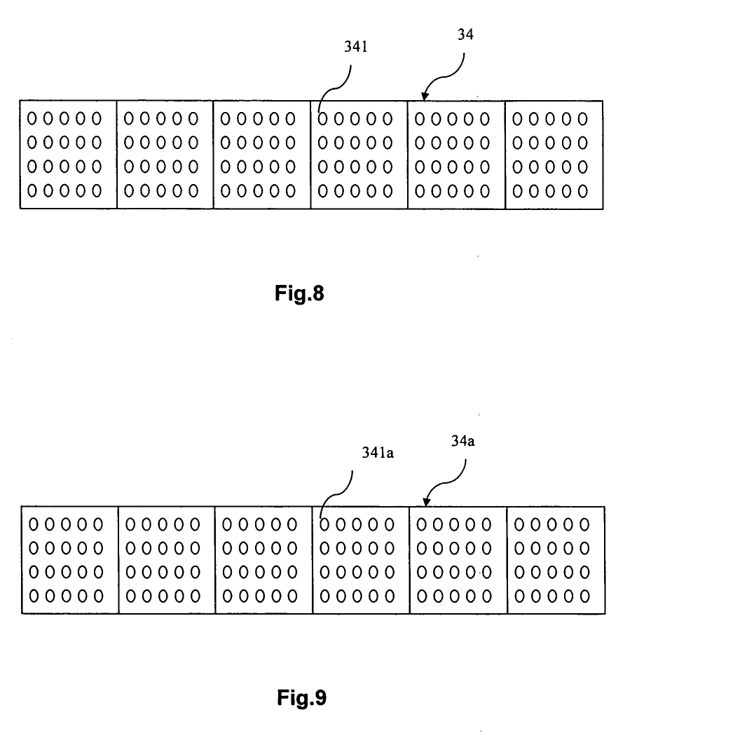

Referring to FIGS. 7, 8 and 9, the air cabinet 3 for photomask boxes according to the third embodiment of the present invention includes an air cabinet body 30, a control unit 32, a chemical filter 38, an ULPA filtering unit 37, and a plurality of laminates 34 each formed with punching holes. The control unit 32 according to this embodiment not only includes the elements described in the second embodiment such as the timer 221, the indicating lamp 222, the indicating lamp 223, the buzzer 224, the air cabinet power switch 225, the air extracting button 226, and the flowmeter 228 but also integrates the elements such as the tachometer 274 and the power switch 273 of the ULPA filtering unit as shown in the second embodiment. The control unit 32 is used to control the flow and the entrance of the air inside the air cabinet body 30, and the way of controlling is the same as that described in second embodiment and is omitted here.

The chemical filter 38 and the ULPA filtering unit 37 are mounted above the air cabinet body 30. The ULPA filtering unit 37 including a fan 371 and an ULPA filtering screen 372 is the same as that in the second embodiment and is used to filter and dry the air before the air enters the cabinet body 30 so that the molecule of the air entering air cabinet is less than 0.5 μm in diameter. The chemical filter 38 and the ULPA filtering unit 37 are connected to each other via a connector 39 mounted above the head of the ULPA filtering unit 37. Since there is more or less some chemical particles or moisture in the air and the molecule weight of moisture is smaller than that of air, the chemical filter 38 is in charge of eliminating certain chemical substances in the air or changing the air into air without chemical ingredients and allows dried and uniformed air to be emitted after the air passes through the ULPA filtering screen 372 and decreases the humidity inside the air cabinet body 30 through double filtering. In this way, the effect caused by the air on the goods storing in the cabinet can be reduced due to the removal of the moisture inside the air cabinet body 30 and the decrease of the frequency of collision between the air molecule and the surface of the stored objects.

A plurality of laminates 34 each formed with punching holes 341 are placed inside the air cabinet body 30. Especially, the laminates 34 are composed of six pieces of punching-hole-plate and transversely placed inside the air cabinet body 30 and parallel to each other, while the punching holes 341 are vertically opposite to each other to allow the air to pass through. According to this embodiment, there are six layers of laminates including the bottom laminate 34a in the air cabinet 3, two laminates for each layer, and thus there will be twelve laminates with punching holes or seventy-two punching-hole-plates for each laminate 34 or 34a is composed of six pieces of punching-hole-plate. The bottom laminate 34a in the air cabinet body 30 is also disposed with punching holes 341a and the punching holes 341 and the punching holes 341a are vertically opposite to each other to allow the outside air to enter the air cabinet body 30 after the air is filtered by the chemical filter 38 and the ULPA filtering unit 37 mounted above the air cabinet body 30. Therefore, the air passes through the punching holes 341 and 341a to produce laminar flow effect inside the air cabinet and fill the air cabinet with air.

On the other hand, there are a plurality of electrically conductive glass windows 33 on the air cabinet body 30 for observing the inside of the air cabinet 30 and eliminating the static electricity of the air cabinet body 30. In addition, there are adjustable foot anchors 351 and actuating wheel 352 under the air cabinet body 30, wherein the adjustable foot anchors 351 have anti-slip and electrically conductive iron chain and the actuating wheel 352 facilitates the movement of the air cabinet.

As shown in the above, the present invention has been clearly illustrated by different embodiments and related drawings. However, it should be understood by one skilled in the art that the embodiments of the present invention demonstrated here are only exemplary rather than limiting. For instance, in the above embodiments, some pieces are not indicated, but it does not mean that these pieces cannot be applied in other embodiments. For example, the temperature-hydrometer 21, reed switch 26, and the air exhausting valve 29 according to the second embodiment can be mounted on the air cabinet according to the third embodiment. For another example, the pressure gage 11 according to the first embodiment can be mounted on the air cabinets according to the second and the third embodiments; and the temperature-hydrometer 21 and the reed switch 26 according to the second embodiment can be mounted on the air cabinet according to the first embodiment. In addition, what is to be emphasized is that, the air used in the air cabinet described in the present invention is not limited to air. Generally speaking, as long as the air is inert gas, such as helium, neon, argon, krypton, xenon, and radon, nitrogen, carbon dioxide, or even air mixed with the above air at certain percentage, it can be applied in the present invention. Accordingly, all such changes and modifications of various elements are encompassed by the present invention without departing from the spirit and scope of the present invention, which is limited only to the appended claims.

What is claimed is:

1. An air cabinet, comprising:
an air cabinet body, the interior of which being provided with a kind of air;
a control unit, mounted on said air cabinet body for controlling the flow and the entrance of said air inside said air cabinet body; and
a plurality of laminates placed inside said air cabinet body for supporting an object, wherein each of said laminates being formed with punching holes.

2. The air cabinet according to claim 1, wherein said air cabinet body comprises a piece of electrically conductive glass for eliminating static electricity of said air cabinet body.

3. The air cabinet according to claim 1, further comprising a plurality of adjustable foot anchors disposed under the bottom of said air cabinet body, each of said adjustable foot anchors having anti-slip and electrically conductive iron chain for eliminating static electricity of said air cabinet body.

4. The air cabinet according to claim 1, further comprising a plurality of actuating wheels disposed under the bottom of said air cabinet body for facilitating the movement of said air cabinet body.

5. The air cabinet according to claim 1, further comprising a pressure gage mounted on said air cabinet body for monitoring the air pressure inside said air cabinet body.

6. The air cabinet according to claim 1, wherein said control unit comprises a timer, at least an indicating lamp, at least a buzzer, a power switch, and a flowmeter.

7. The air cabinet according to claim 1, wherein said plurality of laminates are transversely placed inside said air cabinet body and parallel to each other with the punching holes of the upper laminate facing the punching holes of the lower laminate to allow the air in said air cabinet body to pass through and cause laminar flow.

8. The air cabinet according to claim 1, wherein said air is chosen from the following group: inert gas, nitrogen, carbon dioxide, and mixed air.

9. The air cabinet according to claim 1, wherein said object is a photomask box.

10. An air cabinet, comprising:
an air cabinet body, the interior of which being provided with a kind of air;
a control unit mounted on said air cabinet body for controlling the flow and the entrance of said air inside said air cabinet body;
an ULPA filtering unit, comprising a fan and an ULPA filtering screen to filter said air before said air enters said air cabinet body;
two air return tubes, respectively mounted on any two sides of said air cabinet body for facilitating the circulation of interior air; and
a plurality of laminates placed inside said air cabinet body for supporting an object, wherein each of said laminates being formed with punching holes.

11. The air cabinet according to claim 10, further comprising a plurality of reed switches mounted on said air cabinet body for monitoring the airtight condition of said air cabinet body.

12. The air cabinet according to claim 10, further comprising an air exhausting valve mounted on the bottom of said air cabinet body for releasing air inside said air cabinet body.

13. The air cabinet according to claim 10, wherein said air cabinet body comprises a piece of electrically conductive glass for eliminating static electricity of said air cabinet body.

14. The air cabinet according to claim 10, further comprising a plurality of adjustable foot anchors disposed on the bottom of said air cabinet body, said adjustable foot anchors having anti-slip and electrically conductive iron chain for eliminating static electricity of said air cabinet body.

15. The air cabinet according to claim 10, wherein said control unit comprises a timer, at least an indicating lamp, at least a buzzer, a power switch, and a flowmeter.

16. The air cabinet according to claim 10, wherein said plurality of laminates are transversely placed inside said air cabinet body and parallel to each other with the punching holes of the upper laminate facing the punching holes of the lower laminate to allow the air in said air cabinet body to pass through and cause laminar flow.

17. The air cabinet according to claim 10, further comprising a power switch for starting the ULPA filtering unit and a tachometer for controlling the speed of said fan.

18. The air cabinet according to claim 10, further comprising a temperature-hydrometer mounted on said air cabinet body for monitoring the temperature and humidity inside said air cabinet body.

19. The air cabinet according to claim 10, wherein said ULPA filtering unit dries the air and thereafter the molecule of the filtered air is less than 0.5 μm in diameter.

20. The air cabinet according to claim 10, wherein said air is chosen from the following group: inert gas, nitrogen, carbon dioxide, and mixed air.

21. An air cabinet, comprising:
an air cabinet body, the interior of which being provided with a kind of air;
a control unit mounted on said air cabinet body for controlling the flow and the entrance of said air inside said air cabinet body;
an ULPA filtering unit, comprising a fan and an ULPA filtering screen to filter said air before said air enters said air cabinet body;
a chemical filter for removing chemical pollution mixed in said air; and
a plurality of laminates placed inside said air cabinet body for supporting an object, wherein each of said laminates being formed with punching holes.

22. The air cabinet according to claim 21, wherein said air cabinet body comprises a piece of electrically conductive glass for eliminating static electricity of said air cabinet body.

23. The air cabinet according to claim 21, further comprising a plurality of adjustable foot anchors disposed under the bottom of said air cabinet body.

24. The air cabinet according to claim 21, wherein said plurality of laminates are transversely placed inside said air cabinet body and parallel to each other with the punching holes of the upper laminate facing the punching holes of the lower laminate to allow the air in said air cabinet body to pass through and cause laminar flow.

25. The air cabinet according to claim 21, wherein said air is chosen from the following group: inert gas, nitrogen, carbon dioxide, and mixed air.
